(19) United States
(12) Patent Application Publication
(10) Pub. No.: US 2024/0174124 A1
(43) Pub. Date: May 30, 2024

(54) AUTONOMOUS WORK SYSTEM AND METHOD FOR CONTROLLING AUTONOMOUS WORK MACHINE

(71) Applicant: OMRON Corporation, Kyoto-shi (JP)

(72) Inventors: Katsumi MATSUSHITA, Kyoto-shi (JP); Hiroyuki MINO, Kyoto-shi (JP); Atsushi NOMURA, Kyoto-shi (JP)

(21) Appl. No.: 18/487,121

(22) Filed: Oct. 16, 2023

(30) Foreign Application Priority Data
Nov. 24, 2022 (JP) 2022-187353

(51) Int. Cl. B60L 58/12; B60L 53/12; G05D 1/00

(52) U.S. Cl. CPC B60L 58/12; B60L 53/12; G05D 1/0088; B60L 2200/40

(57) ABSTRACT

An autonomous work system includes an autonomous work machine, a plurality of supplementary charging stations, and a controller. The autonomous work machine moves along a work route that sequentially passes through multiple work positions and performs a predetermined task at each of the work positions. The plurality of supplementary charging stations are arranged along the work route to charge the battery by wireless power transfer. The controller acquires a remaining charge of the battery. The controller determines whether additional charging of the battery is necessary in a middle of the work route based on the remaining charge of the battery. The controller determines the work route to move the autonomous work machine to one of the plurality of supplementary charging stations in a middle of the work route to perform the additional charging of the battery upon determining that the additional charging is necessary.

### CROSS-REFERENCE TO RELATED APPLICATION

This application claims priority to Japanese Patent Application No. 2022-187353, filed Nov. 24, 2022. The contents of that application are incorporated by reference herein in their entirety.

### FIELD

The claimed invention relates to an autonomous work system and a method for controlling an autonomous work machine.

### BACKGROUND

Conventionally, there has been known an autonomous work system in which an autonomous work machine autonomously travels along a work route and performs a task at a predetermined work position. For example, Japanese Patent Application Laid-Open No. 2022-112212 discloses an autonomous mobile system in which an autonomous mobile robot travels within a predetermined area.

In the autonomous work system, the autonomous work machine is fully charged at the start position. The autonomous work machine sequentially moves to a plurality of work positions along a work route and performs a task at each of the work positions. After the work is completed, the autonomous work machine returns to the start position and is charged. By repeating such steps, the autonomous work machine continuously performs the task.

However, in the above system, the work completely stops while the autonomous work machine is being charged. As a result, work efficiency is reduced. In order to avoid or reduce a decrease in work efficiency due to charging, it is necessary to alternately perform charging and the tasks using multiple autonomous work machines. In that case, the number of required autonomous work machines will increase. In addition, the traveling distance of the autonomous work machine is long in a vast facility. Therefore, the autonomous work machine requires a large-capacity battery. This increases the cost of the system.

### SUMMARY

An object of the claimed invention is to reduce a decrease in work efficiency due to charging of an autonomous work machine and to reduce the cost of an autonomous work system. An autonomous work system according to one aspect of the claimed invention includes an autonomous work machine, a plurality of supplementary charging stations, and a controller. The autonomous work machine includes a battery. The autonomous work machine moves along a work route that sequentially passes through a plurality of work positions, and performs a predetermined task at each of the plurality of work positions. The plurality of supplementary charging stations are positioned along the work route to charge the battery by wireless power transfer. The controller controls the autonomous work machine. The controller acquires the remaining charge of the battery. The controller determines whether additional charging of the battery is necessary during the work route based on the remaining charge of the battery. When the controller determines that additional charging is necessary, the controller determines the work route so that the autonomous work machine moves to one of the plurality of supplementary charging stations in a middle of the work route to perform additional charging of the battery.

A method according to another aspect of the claimed invention is a method for controlling an autonomous work machine. The autonomous work machine includes a battery. The method includes: moving the autonomous work machine along a work route that sequentially passes through a plurality of work positions to perform a predetermined task at each of a plurality of work positions; obtaining a remaining charge of the battery; determining whether additional charging of the battery is necessary during the work route based on the remaining charge of the battery; and determining the work route so that the autonomous work machine moves to one of the plurality of supplementary charging stations during the work route to charge the battery by wireless power transfer upon determining the additional charging of the battery is necessary. The plurality of supplementary charging stations are positioned along the work route to charge the battery by wireless power transfer.

According to the claimed invention, when it is determined that additional charging is necessary, the autonomous work machine moves to one of the plurality of supplementary charging stations in the middle of the work route to perform additional charging of the battery. Therefore, the autonomous work machine performs additional charging when additional charging is necessary while moving on the work route. Therefore, it is possible to reduce reduction in efficiency due to long-time charging. In addition, the number of required autonomous work machines is reduced, and the capacity required for the battery of the autonomous work machine is reduced. The cost of the system is thereby reduced.

Moreover, according to the claimed invention, the number of times of charging is increased. Therefore, when charging by the contact is used, there is a concern that poor contact may occur over time. However, in the claimed invention, such a concern is resolved by using wireless power transfer.

### BRIEF DESCRIPTION OF THE DRAWINGS

FIG. 1 is a plan view illustrating an autonomous work system and a work area according to an embodiment of the claimed invention.

FIG. 2 is a block diagram showing a configuration of an autonomous work machine and a main charging station.

FIG. 3 is a flow chart showing processing for determining a work route.

FIG. 4 is a diagram showing an example of the work route.

FIG. 5 is a diagram illustrating another example of the work route.

### DETAILED DESCRIPTION

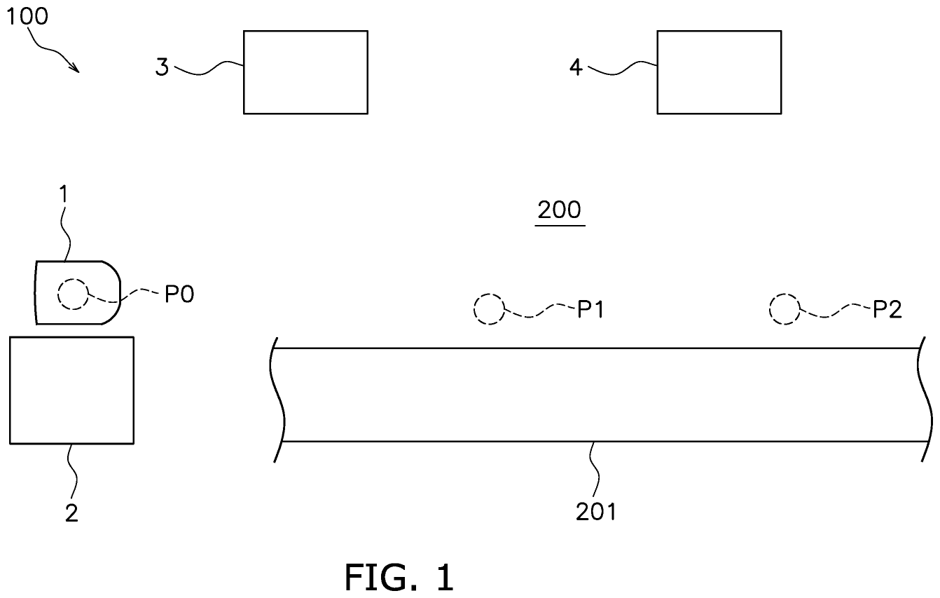

An autonomous work system according to an embodiment of the claimed invention will be described below with reference to the drawings. FIG. 1 is a plan view illustrating an autonomous work system 100 according to the present embodiment and a work area 200 in which the autonomous work system 100 is arranged. The work area 200 may, for example, be an area within a factory. A production line 201 is arranged in the work area 200.

The autonomous work system 100 includes an autonomous work machine 1, a main charging station 2, and a plurality of supplementary charging stations 3 and 4. The autonomous work machine 1 may, for example, be a transport vehicle that carries parts. The main charging station 2 is arranged in the work area 200. The main charging station 2 supplies electric power to the autonomous work machine 1. The main charging station 2 is also a standby place for the autonomous work machine 1 while it is not working. The main charging station 2 is arranged at a start position P0 at the start of work.

At the start of work, the autonomous work machine 1 departs from the main charging station 2 and moves within the work area 200 along a work route that sequentially passes through a plurality of work positions P1 and P2 and performs a predetermined task at each of the plurality of work positions P1 and P2. The predetermined task may, for example, be transportation of parts. The autonomous work machine 1 moves to each of the work position P1 and P2 and places parts on the production line 201 at each of the work positions P1 and P2. Alternatively, the predetermined task may include assembling parts.

The plurality of supplementary charging stations 3 and 4 are arranged in the middle of the work route. The plurality of supplementary charging stations 3 and 4 supply electric power to the autonomous work machine 1 by wireless power transfer. The autonomous work machine 1 automatically moves to the main charging station 2 or the plurality of supplementary charging stations 3 and 4 and is charged at the main charging station 2 or the plurality of supplementary charging stations 3 and 4.

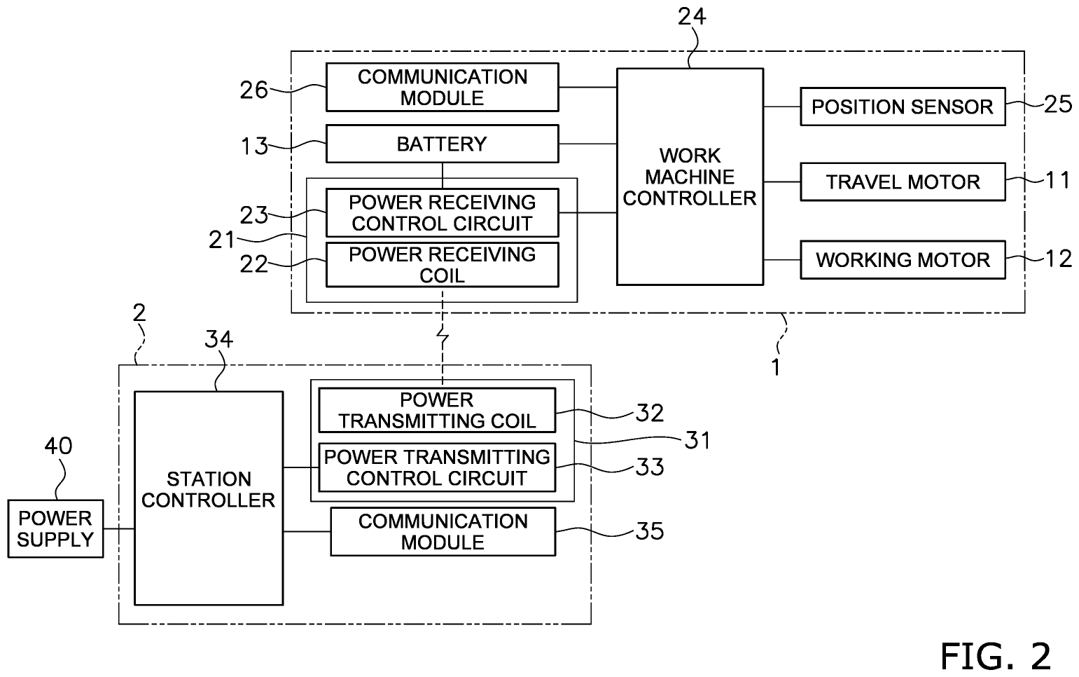

FIG. 2 is a block diagram showing the configuration of the autonomous work machine 1 and the main charging station 2. As shown in FIG. 2, the autonomous work machine 1 includes a travel motor 11, a working motor 12, and a battery 13. The travel motor 11 and the working motor 12 may be electric motors. The travel motor 11 causes the autonomous work machine 1 to travel.

The working motor 12 drives an actuator for performing the task of the autonomous work machine 1. Thereby, the autonomous work machine 1 performs the task. The actuator may, for example, be a robotic arm. The battery 13 supplies electric power to the travel motor 11 and the working motor 12. The autonomous work machine 1 autonomously travels to each of the work positions P1 and P2 by the electric power stored in the battery 13, and performs the task at each of the work positions P1 and P2.

The autonomous work machine 1 includes a power receiver unit 21 for wireless power transfer. The main charging station 2 includes a power transmitter unit 31 for wireless power transfer. The power transmitter unit 31 includes a power-transmitting coil 32 and a power-transmitting control circuit 33. The power-transmitting coil 32 is a coil for power supply. The power-transmitting control circuit 33 converts the electric power supplied from the commercial power supply 40 into the electric power of a predetermined frequency for generating a magnetic field in the power-transmitting coil 32 and supplies the electric power to the power-transmitting coil 32.

The power receiver unit 21 includes a power-receiving coil 22 and a power-receiving control circuit 23. The power-receiving coil 22 is a coil for power extraction. The power-receiving coil 22 is magnetically coupled with the power-transmitting coil 32 and receives the electric power from the power-transmitting coil 32 by electromagnetic induction. Note that the electromagnetic induction method may include means for forming a resonance circuit in at least one of the power-transmitting coil 32 and the power-receiving coil 22. The power-receiving control circuit 23 converts electric power generated by the power-receiving coil 22 into electric power for charging the battery 13 and supplies the battery 13 with the electric power. The battery 13 is thereby charged.

The autonomous work machine 1 includes a work-machine controller 24. The work-machine controller 24 controls an operation of the autonomous work machine 1. The work-machine controller 24 includes, for example, a processor such as a CPU (Central Processing Unit), and memories such as RAM (Random Access Memory) and ROM (Read Only Memory). The work-machine controller 24 stores data and programs for performing the task by the autonomous work machine 1. For example, the work-machine controller 24 stores the position of the main charging station 2. The work-machine controller 24 causes the autonomous work machine 1 to return to the main charging station 2 after finishing the tasks.

The autonomous work machine 1 includes a position sensor 25. The position sensor 25 detects the position of the autonomous work machine 1. The position sensor 25 may include, for example, an IMU (Inertial Measurement Unit). Alternatively, the position sensor 25 may include a receiver such as a GPS (Global Positioning System).

The main charging station 2 includes a station controller 34. The station controller 34 includes, for example, a processor such as a CPU (Central Processing Unit), and memories such as RAM (Random Access Memory) and ROM (Read Only Memory). The station controller 34 controls power transfer by the power transmitter unit 31.

The main charging station 2 includes a communication module 35. The autonomous work machine 1 includes a communication module 26. The communication modules 26 and 35 perform wireless communication using, for example, infrared rays or radio waves. The main charging station 2 and the autonomous work machine 1 transmit and receive data via the communication modules 26 and 35.

When the autonomous work machine 1 reaches the main charging station 2, the battery 13 is charged by wireless power transfer between the power receiver unit 21 and the power transmitter unit 31. The supplementary charging stations 3 and 4 have the same configuration as the main charging station 2. When the autonomous work machine 1 reaches the supplementary charging stations 3 and 4, the battery 13 is charged by wireless power transfer by the power receiver unit 21 and the power transmitter units of the supplementary charging stations 3 and 4.

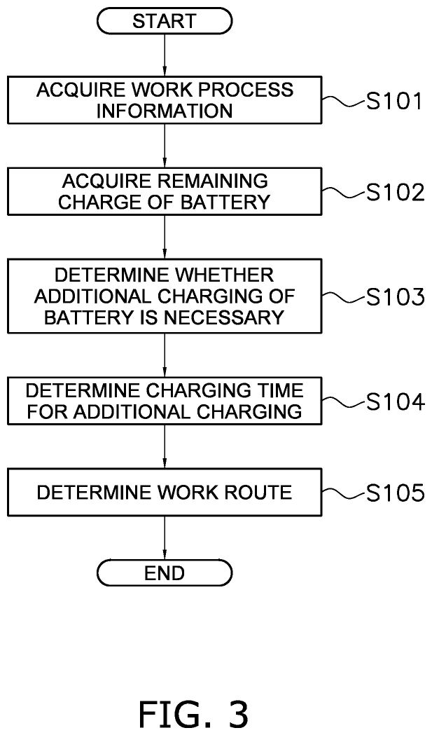

Next, a method for determining the work route of the autonomous work machine 1 will be described. FIG. 3 is a flow chart showing processing for determining the work route. As shown in FIG. 3, in step S101, the work-machine controller acquires work process information. The work process information is information related to the task performed by the autonomous work machine 1. The work-machine controller 24 acquires the work process information from the main charging station 2 at the start position P0. Alternatively, the work-machine controller 24 may acquire the work process information from a management computer of the work area 200 through wireless communication such as a wireless LAN.

The work process information includes the positions of the plurality of work positions P1 and P2. The work process information includes distances between the plurality of work positions P1 and P2. The work process information includes a work amount of the autonomous work machine for performing the task. The work amount is indicated by, for example, the amount of electric power consumed by the autonomous work machine for performing the task. The work process information includes the positions of the plurality of supplementary charging stations 3 and 4. In step S102, the work-machine controller 24 acquires the remaining charge of the battery 13.

In step S103, the work-machine controller 24 determines whether additional charging of the battery 13 is necessary. Based on the work process information and the remaining charge of the battery 13, the work-machine controller 24 determines whether additional charging of the battery 13 is necessary in the middle of the work route. The work-machine controller 24 calculates the expected power consumption in the autonomous work machine 1 from the work process information. The expected power consumption includes the power consumption due to the task and the power consumption due to movement. The work-machine controller 24 determines whether additional charging of the battery 13 is necessary during the work route based on the expected power consumption and the remaining charge of the battery 13.

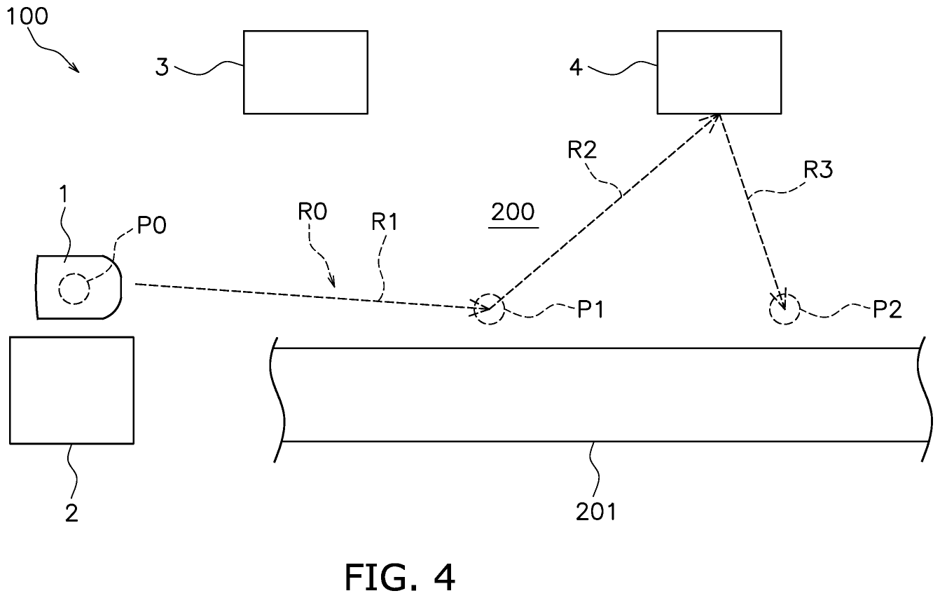

For example, as shown in FIG. 4, the plurality of work positions P1 and P2 include a first work position P1 and a second work position P2. The first work position P1 is a work position subsequent to the start position P0. The second work position P2 is a work position subsequent to the first work position P1. The plurality of supplementary charging stations 3 and 4 includes a first charging station 3 and a second charging station 4. The first charging station 3 is arranged between the start position P0 and the first work position P1. The second charging station 4 is arranged between the first work position P1 and the second work position P2.

The work-machine controller 24 determines whether the remaining charge of the battery 13 at the start position P0 is sufficient for a required power amount to the first work position P1. The required power amount to the first work position P1 includes the power amount required for movement from the start position P0 to the first work position P1 and the power amount required for the task at the first work position P1. When the remaining charge of the battery 13 is sufficient for the required power amount to the first work position P1, the work-machine controller 24 determines the first route R1 for moving directly from the start position P0 to the first work position P1.

The work-machine controller 24 determines whether the remaining charge of the battery 13 at the first work position P1 is sufficient for a required power amount from the first work position P1 to the second work position P2. The required power amount to the second work position P2 includes the power amount required for movement from the first work position P1 to the second work position P2 and the power amount required for the task at the second work position P2. When the remaining charge of the battery 13 at the first work position P1 is insufficient for the required power amount to the second work position P2, the work-machine controller 24 determines a second route R2 and a third route R3 passing through the nearest second charging station 4 on the way from the first work position P1 to the second work position P2. The second route R2 is a route from the first work position P1 to the second charging station 4. The third route R3 is a route from the second charging station 4 to the second work position P2. As described above, the work-machine controller 24 determines whether additional charging is necessary between the work positions P1 and P2.

In step S104, the work-machine controller 24 determines a charging time for additional charging. In the example shown in FIG. 4, the work-machine controller 24 determines the charging time for additional charging at the second charging station 4 based on the remaining charge of the battery 13 and the required power amount to the second work position P2. For example, the work-machine controller 24 determines the charging time for additional charging so that the remaining charge of the battery 13 is greater than or equal to the required power amount to the second work position P2. Alternatively, the work-machine controller 24 may determine the charging time for additional charging such that the remaining charge of the battery 13 is greater than or equal to the required power amount to the plurality of work positions.

In step S105, the work-machine controller 24 determines a work route R0. As shown in FIG. 4, the controller determines the work route R0 that includes the first route R1, the second route R2, and the third route R3. The work-machine controller 24 causes the autonomous work machine 1 to move according to the work route R0 determined as described above.

As a result, the autonomous work machine 1 moves directly from the start position P0 to the first work position P1 along the first route R1, and performs the task at the first work position P1. After completing the task at the first work position P1, the autonomous work machine 1 moves from the first work position P1 to the second charging station 4 along the second route R2. The autonomous work machine 1 is charged at the second charging station 4 during the charging time described above. The autonomous work machine 1 moves from the second charging station 4 to the second work position P2 along the third route R3, and performs the task at the second work position P2. Note that the number of work positions is not limited to two. The work-machine controller 24 may determine the work route R0 for three or more work positions by performing the same processing as described above.

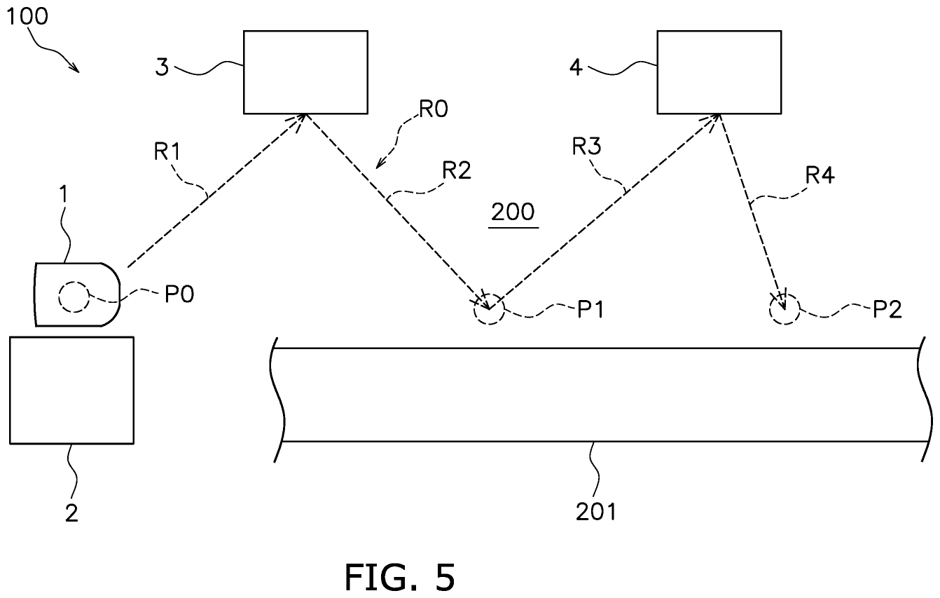

FIG. 5 is a diagram showing a work route R0 according to another example. As shown in FIG. 5, when the remaining charge of the battery 13 at the start position P0 is insufficient for the required power amount from the start position P0 to the first work position P1, the work-machine controller 24 determines a first route R1 and a second route R2 passing through the nearest first charging station 3 on the way from the start position P0 to the first work position P1. The first route R1 is a route from the start position P0 to the first charging station 3. The second route R2 is a route from the first charging station 3 to the first work position P1.

When the remaining charge of the battery 13 at the first work position P1 is insufficient for the required power amount from the first work position P1 to the second work position P2, the work-machine controller 24 determines a third route R3 and a fourth route R4 passing through the nearest second charging station 4 on the way from the first work position P1 to the second work position P2. The third route R3 is a route from the first work position P1 to the second charging station 4. The fourth route R4 is a route from the second charging station 4 to the second work position P2. As described above, the work-machine controller 24 determines the work route R0 including the first route R1, the second route R2, the third route R3, and the fourth route R4. The work-machine controller 24 causes the autonomous work machine 1 to move according to the work route R0 determined as described above.

It should be noted that the work-machine controller 24 charges the autonomous work machine 1 at the main charging station 2 when the remaining charge of the battery 13 at the start position P0 is insufficient for the required power amount to the first work position P1. In that case, the work-machine controller 24 may determine the charging time at the main charging station 2 based on the remaining charge of the battery 13 at the start position P0 and the required power amount to the first work position P1.

According to the autonomous work system 100 according to the present embodiment described above, when it is determined that additional charging is necessary, the autonomous work machine 1 moves to one of the plurality of supplementary charging stations 3 and 4 in the middle of the work route R0 to perform additional charging of the battery 13. Therefore, the autonomous work machine 1 performs additional charging in a plurality of times each time additional charging is necessary while moving along the work route R0. Therefore, it is possible to limit a decrease in work efficiency due to long-time charging. In addition, the number of required autonomous work machines is reduced, and the required capacity of the battery 13 of the autonomous work machine 1 is reduced. Thereby, the cost of the autonomous work system 100 is reduced.

Moreover, according to the method for determining the work route R0 described above, the number of times of charging increases. Therefore, when charging by contact is used, there is a concern that poor contact may occur over time. However, in the autonomous work system 100 according to the present embodiment, such a concern is resolved by using wireless power transfer.

Although one embodiment of the claimed invention has been described above, the claimed invention is not limited to the above-described embodiment, and various modifications are possible without departing from the scope of the invention.

The configuration of the autonomous work system 100 is not limited to that of the above embodiment and may be modified. The autonomous work machine 1 is not limited to a transport vehicle, and may be another work machine. For example, the autonomous work machine 1 may be a lawn mower. In that case, the work area may be an outdoor field. The predetermined task may be lawn mowing, and the work position may be a predetermined section that is the target of lawn mowing.

The arrangement of the supplementary charging stations 3 and 4 is not limited to that of the above embodiment and may be changed. For example, the supplementary charging stations 3 and 4 may be arranged on the travel route or at the work position. The number of supplementary charging stations is not limited to two, and may be more than two.

Processing for determining the work route R0 is not limited to that of the above embodiment and may be modified. For example, the work-machine controller 24 may determine the work route to the next work position after finishing the task at each of the work positions. For example, the work-machine controller 24 may determine a work route from the start position P0 to the first work position P1. The work-machine controller 24 may determine the work route to the second work position P2 after finishing the task at the first work position P1.

Processing for determining the work route R0 may be executed not only by the work-machine controller 24, but also by the station controller 34 or another computer. In that case, the work-machine controller 24 may receive data indicating the determined work route R0 and autonomously causes the autonomous work machine 1 to move and work along the work route R0.

### REFERENCE SIGNS LIST

1: Autonomous work machine, 3, 4: Supplementary charging station, 13: Battery, 24: Work-machine controller, 34: Station controller, P0: Start position, P1: First work position, P2: Second work position, R0: Work route

1. An autonomous working system, comprising:
an autonomous work machine including a battery, the autonomous work machine being configured to move along a work route that sequentially passes through a plurality of work positions and performs a predetermined task at each of the plurality of work positions;
a plurality of supplementary charging stations arranged along the work route, each of the plurality of supplementary charging stations being configured to charge the battery by wireless power transfer; and
a controller, the controller being configured to obtain a remaining charge of the battery; to determine whether additional charging of the battery is necessary in a middle of the work route based on the remaining charge of the battery; and to determine the work route to move the autonomous work machine to one of the plurality of supplementary charging stations in the middle of the work route to perform the additional charging of the battery upon determining that additional charging is necessary.

2. The autonomous work system according to claim 1, wherein the controller is further configured to acquire work process information related to the predetermined task and to determine whether additional charging of the battery in the middle of the work route is necessary based on the work process information and the remaining charge of the battery.

3. The autonomous work system according to claim 2, wherein the controller is further configured to determine a charging time for the additional charging based on the work process information and the remaining charge of the battery.

4. The autonomous work system according to claim 2, wherein the controller is further configured to calculate an expected power consumption of the autonomous work machine from the work process information and to determine whether the additional charging of the battery is necessary in the middle of the work route based on the expected power consumption and the remaining charge of the battery.

5. The autonomous work system according to claim 2, wherein the work process information includes a distance between the plurality of work positions.

6. The autonomous work system according to claim 2, wherein the work process information includes a work amount of the predetermined task.

7. The autonomous work system according to claim 2, wherein the work process information includes positions of the plurality of work positions and the plurality of supplementary charging stations.

8. The autonomous work system according to claim 1, wherein the plurality of work positions includes a first work position and a second work position next to the first work position, and
the controller is further configured to determine whether the remaining charge of the battery is sufficient for a required power amount to the second work position; to control the autonomous work machine to move directly from the first work position to the second work position when the remaining charge of the battery is sufficient for the required power amount to the second work position; and to determine the work route to move the autonomous work machine to one of the supplementary charging stations to perform the additional charging of the battery between the first work position and the second work position when the remaining charge of the battery is insufficient for the required power amount to the second work position.

9. The autonomous work system according to claim 8, wherein the controller is further configured to determine a charging time for the additional charging based on the remaining charge of the battery and the required power amount to the second work position.

10. The autonomous work system according to claim 1, wherein
the work route includes a start position,
the plurality of work positions includes a first work position next to the start position, and
the controller is further configured to determine whether the remaining charge of the battery is sufficient for a required power amount to the first work position; to control the autonomous work machine to move directly from the start position to the first work position when the remaining charge of the battery is sufficient for the required power amount to the first work position; and to determine the work route to move the autonomous work machine to one of the plurality of supplementary charging stations between the start position and the first work position to perform the additional charging of the battery when the remaining charge of the battery is insufficient for the required power amount to the first work position.

11. The autonomous work system according to claim 1, further comprising a main charging station, wherein
the work route includes a start position,
the main charging station is arranged at the start position,
the plurality of work positions includes a first work position next to the start position, and
the controller is further configured to determine whether the remaining charge of the battery is sufficient for a required power amount to the first work position; to control the autonomous work machine to move directly from the start position to the first work position when the remaining charge of the battery is sufficient for the required power amount to the first work position; and to control the autonomous work machine to charge the autonomous work machine at the main charging station when the remaining charge of the battery is insufficient for the required power amount to the first work position.

12. The autonomous work system according to claim 11, wherein the controller is further configured to determine a charging time at the main charging station based on the remaining charge of the battery and the required power amount to the first work position.

13. A method for controlling an autonomous work machine that includes a battery and that is configured to move along a work route that sequentially passes through a plurality of work positions to perform a predetermined task at each of the plurality of work positions, the method comprising:
obtaining a remaining charge of the battery;
determining whether additional charging of the battery is necessary in a middle of the work route based on the remaining charge of the battery; and
determining the work route to move the autonomous work machine to one of a plurality of supplementary charging stations that are arranged along the work route and to charge the battery by wireless power transfer to perform the additional charging of the battery in a middle of the work route upon determining that the additional charging is necessary.
